(19) United States
(12) Patent Application Publication
(10) Pub. No.: US 2021/0260543 A1
(43) Pub. Date: Aug. 26, 2021

(54) Mixer

(71) Applicant: David A. Homan, Candler, NC (US)

(72) Inventor: David A. Homan, Candler, NC (US)

(21) Appl. No.: 17/185,509

(22) Filed: Feb. 25, 2021

Related U.S. Application Data
(60) Provisional application No. 62/981,236, filed on Feb. 25, 2020.

(51) Int. Cl. B01F 13/00; B01F 15/00; B01F 7/00

(52) U.S. Cl. CPC B01F 13/0028; B01F 13/0033; B01F 7/00291; B01F 15/0048; B01F 15/00506

(57) ABSTRACT

A mixer for use in combination with a bucket and a drill includes an annular rim sized and configured for selective attachment to the bucket; a mixing extension component, the distal end thereof including blades for mixing one or more liquids in the bucket; an opening on the annular rim, the opening being sized for passage of the mixing extension component; a connector component configured for attachment to the distal end of the mixing extension component; a rim member of the connector component configured for being secured about the interior opening of the annular rim for stabilizing the mixing extension component; a manual rotating component; an adapter component configured to be secured to the connector component; and wherein a user can selectively and interchangeably operate the mixer using the drill and the manual rotating component.

### RELATED APPLICATION

This application claims priority to and incorporates entirely by reference U.S. Provisional Patent Application Ser. No. 62/981,236 filed on Feb. 25, 2020.

### BACKGROUND

Proper mixing of mortar, drywall patch, concrete and paint can present several challenges. Mixing by hand is time consuming and inefficient and, while certain improvements have been made which utilize electric equipment, there exists a need for improved mixing without necessarily needing electric equipment.

A mixer, such as for, but not limited to, mixing mortar, drywall patch, concrete and paint, is disclosed.

### SUMMARY

In accordance with one form of the invention, there is provided a mixer for use in combination with a bucket, the mixer including an annular rim sized and configured for selective attachment to the bucket; a mixing extension component including a distal end and a proximal end, the distal end including a plurality of blades configured for mixing one or more liquids in the bucket; an interior opening defined by an interior inner surface on the annular rim, the interior opening being sized for passage of the mixing extension component; a connector component configured for attachment to the proximal end of the mixing extension component; a rim member of the connector component configured for being secured about the interior opening of the annular rim for stabilizing the mixing extension component; and wherein a manual rotating component includes a threaded exterior surface for engaged receipt of a corresponding thread on the connector component such that a user can selectively operate the mixer by rotating the manual rotating component.

In accordance with another form of the invention, there is provided a mixer for use in combination with a bucket, the mixer including an annular rim sized and configured for selective attachment to the bucket; a mixing extension component including a distal end and a proximal end, the distal end including a plurality of blades configured for mixing one or more liquids in the bucket; an interior opening defined by an interior inner surface on the annular rim, the interior opening being sized for passage of the mixing extension component; a connector component configured for attachment to the distal end of the mixing extension component; a rim member of the connector component configured for being secured about the interior opening of the annular rim for stabilizing the mixing extension component; an adapter component configured to be secured to the connector component; a motorized device having a rotating shaft; and wherein the adapter component includes a threaded exterior surface for engaged receipt of a corresponding thread on the connector component such that a user can selectively operate the mixer using the motorized device.

In accordance with another form of the present invention, there is provided a mixer for use in combination with a bucket and a drill, the mixer including an annular rim sized and configured for selective attachment to the bucket; a mixing extension component including a distal end and a proximal end, the distal end including a plurality of blades configured for mixing one or more liquids in the bucket; an interior opening defined by an interior inner surface on the annular rim, the interior opening being sized for passage of the mixing extension component; a connector component configured for attachment to the distal end of the mixing extension component; a rim member of the connector component configured for being secured about the interior opening of the annular rim for stabilizing the mixing extension component; a manual rotating component; an adapter component configured to be secured to the connector component; and wherein the adapter component and the manual rotating component each includes a threaded exterior surface for engaged receipt of a corresponding thread on the connector component such that a user can selectively and interchangeably operate the mixer using the drill and the manual rotating component.

### BRIEF DESCRIPTION OF DRAWINGS

For a fuller understanding of the nature of the present invention, reference should be made to the following detailed description, taken in conjunction with the accompanying drawings in which:

FIG. 1 shows the annular rim of the mixer secured to a bucket.

FIG. 2 shows the mixing extension component of the mixer.

FIG. 3 is a perspective view of the connector component of the mixer.

FIG. 4 is a perspective view of the annular rim, mixing extension component and connector component of the mixer assembled and secured to a bucket.

FIG. 5 is a perspective view of the annular rim, mixing extension component and connector component of the mixer assembled with a manual rotating component and secured to a bucket.

FIG. 6 is a perspective view of the adapter component.

FIG. 7 is a perspective view of the annular rim, mixing extension component, connector component and adapter component of the mixer assembled and secured to a bucket, and a drill selectively attached with the adapter component of the mixer.

Like reference numerals refer to like parts throughout the several views of the drawings.

### DETAILED DESCRIPTION

The mixer of the present invention is shown in accordance with multiple embodiments and is generally referred to as 10.

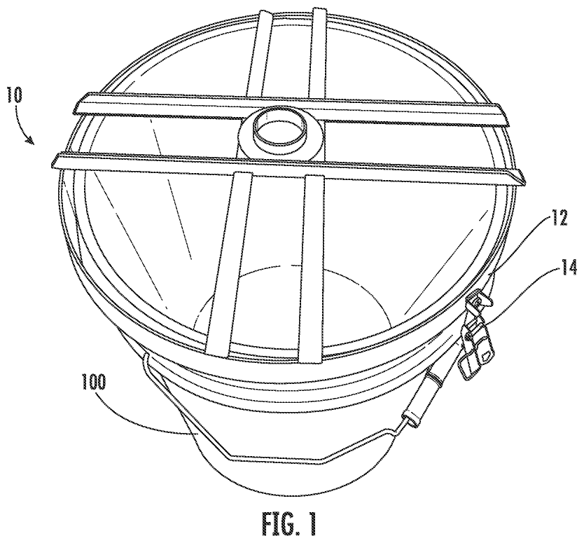

FIG. 1 shows the annular rim 12 secured to a bucket 100 wherein the annular rim 12 may be selectively attached to the bucket 100 by a user. In accordance with one embodiment, the annular rim includes a latch clamp 14 for tightening the inner facing surface of annular rim 12 around the rim of the bucket 100.

The annular rim 12 includes an interior opening defined by an interior inner surface. The interior inner surface is preferably centrally located on the annular rim 12. The interior inner surface is sized for passage of a mixing extension component 16 (see FIG. 2). The mixing extension component 16 includes a distal end 18 and a proximal end 20. The distal end 18 includes a plurality of blades 22 for mixing one or more liquids in the bucket 100. In one embodiment, at least one of the blades includes a scraper 23 that is configured to come in abutment with the bottom of the bucket 100. The scraper 23 is preferably formed from rubber or similar material. In one embodiment, an annular frame 24 surrounds the blades 22.

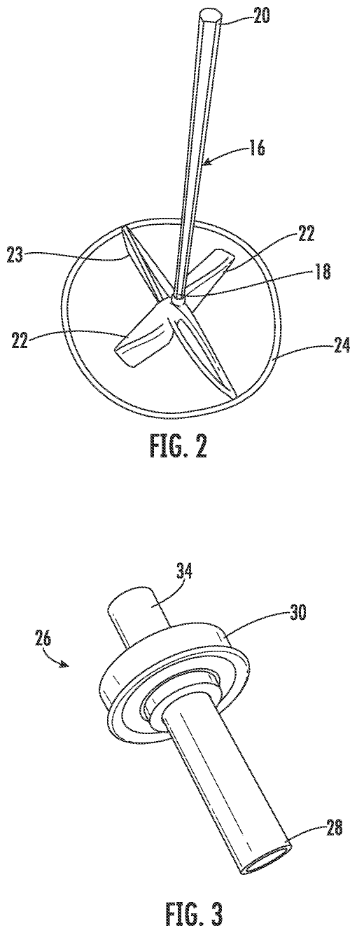

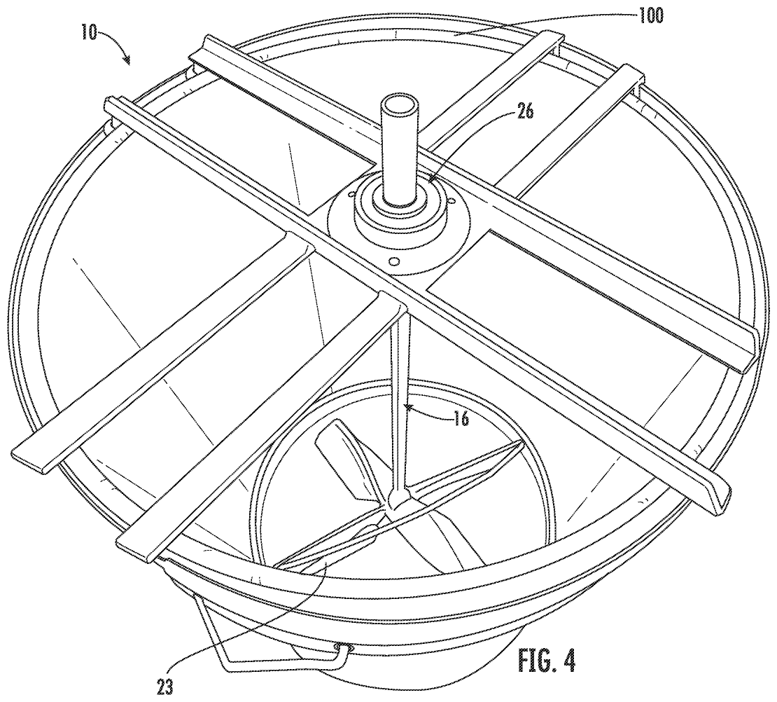

Wither reference to FIGS. 3 and 4, a connector component 26 is shown. A first end 28 of the connector component is sized and configured for attachment to the proximal end 20 of the mixing extension component 16. The inner facing surface of the connector component is threaded for engaged receipt of the proximal end 20. A rim member 30 of the connector component 26 is secured about the interior opening of the annular rim 12 for stabilizing the mixing extension component 16.

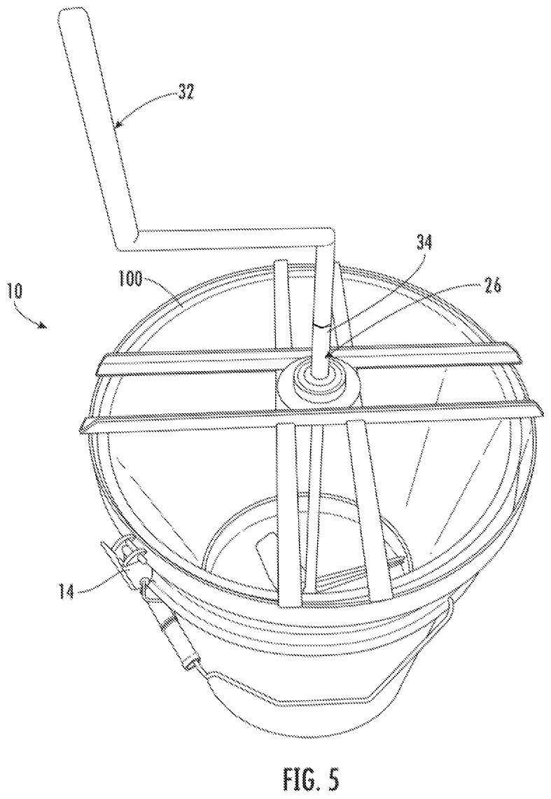

FIG. 5 is a perspective view of the annular rim 12, mixing extension component 16 and connector component 26 of the mixer 10 assembled with a manual rotating component 32 secured to a second end 34 of the connector component 26. The manual rotating component 32 includes a first vertical member and a second vertical member offset from the first vertical member by a horizontal member, wherein the first vertical member includes a threaded exterior surface for engaged receipt of a corresponding thread on the second end 34 of the connector component 26 such that a user can selectively operate the mixer 10 by rotating the manual rotating component 32.

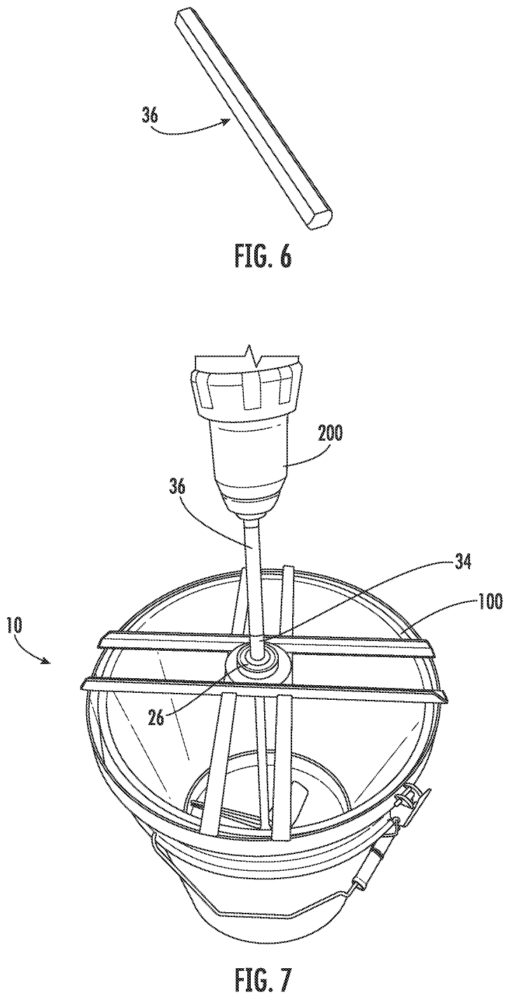

Referring now to FIGS. 6 and 7, an adapter component 36 may be secured to the second end 34 of the connector component 26. The adapter component 36 includes a threaded exterior surface for engaged receipt of a corresponding thread on the second end 34 of the connector component 26 such that a user can selectively operate the mixer 10 using a drill 200. It is understood that other motorized devices having a rotating shaft may be sized and configured to attach to the mixer as well.

A mixer for use in combination with a bucket, as disclosed herein, comprises:

an annular rim sized and configured for selective attachment to the bucket;

a mixing extension component including a distal end and a proximal end, the distal end including a plurality of blades configured for mixing one or more liquids in the bucket;

an interior opening defined by an interior inner surface on the annular rim, the interior opening being sized for passage of the mixing extension component;

a connector component configured for attachment to the proximal end of the mixing extension component;

a rim member of the connector component configured for being secured about the interior opening of the annular rim for stabilizing the mixing extension component; and

wherein a manual rotating component includes a threaded exterior surface for engaged receipt of a corresponding thread on the connector component such that a user can selectively operate the mixer by rotating the manual rotating component.

A mixer for use in combination with a bucket and a drill, as disclosed herein, comprises:

an annular rim sized and configured for selective attachment to the bucket;

a mixing extension component including a distal end and a proximal end, the distal end including a plurality of blades configured for mixing one or more liquids in the bucket;

an interior opening defined by an interior inner surface on the annular rim, the interior opening being sized for passage of the mixing extension component;

a connector component configured for attachment to the distal end of the mixing extension component;

a rim member of the connector component configured for being secured about the interior opening of the annular rim for stabilizing the mixing extension component;

an adapter component configured to be secured to the connector component; and

wherein the adapter component includes a threaded exterior surface for engaged receipt of a corresponding thread on the connector component such that a user can selectively operate the mixer using the drill.

A mixer for use in combination with a bucket and a drill, as disclosed herein, comprises:

an annular rim sized and configured for selective attachment to the bucket;

a mixing extension component including a distal end and a proximal end, the distal end including a plurality of blades configured for mixing one or more liquids in the bucket;

an interior opening defined by an interior inner surface on the annular rim, the interior opening being sized for passage of the mixing extension component;

a connector component configured for attachment to the distal end of the mixing extension component;

a rim member of the connector component configured for being secured about the interior opening of the annular rim for stabilizing the mixing extension component;

a manual rotating component;

an adapter component configured to be secured to the connector component; and

wherein the adapter component and the manual rotating component each includes a threaded exterior surface for engaged receipt of a corresponding thread on the connector component such that a user can selectively and interchangeably operate the mixer using the drill and the manual rotating component.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

What is claimed is:

1. A mixer for use in combination with a bucket, the mixer comprising:
an annular rim sized and configured for selective attachment to the bucket;
a mixing extension component including a distal end and a proximal end, the distal end including a plurality of blades configured for mixing one or more liquids in the bucket;
an interior opening defined by an interior inner surface on the annular rim, the interior opening being sized for passage of the mixing extension component;
a connector component configured for attachment to the proximal end of the mixing extension component; and
a rim member of the connector component configured for being secured about the interior opening of the annular rim for stabilizing the mixing extension component.

2. The mixer as recited in claim 1 further comprising a manual rotating component, the manual rotating component including a threaded exterior surface for engaged receipt of a corresponding thread on the connector component such that a user can selectively operate the mixer by rotating the manual rotating component.

3. The mixer as recited in claim 1 further comprising an adapter component and a motorized device having a rotating shaft, wherein the adapter component includes a threaded exterior surface for engaged receipt of a corresponding thread on the connector component such that a user can selectively operate the mixer using the motorized device.

4. The mixer as recited in claim 3 wherein the motorized device is a drill.

5. A mixer for use in combination with a bucket and a drill, the mixer comprising:
an annular rim sized and configured for selective attachment to the bucket;
a mixing extension component including a distal end and a proximal end, the distal end including a plurality of blades configured for mixing one or more liquids in the bucket;
an interior opening defined by an interior inner surface on the annular rim, the interior opening being sized for passage of the mixing extension component;
a connector component configured for attachment to the distal end of the mixing extension component;
a rim member of the connector component configured for being secured about the interior opening of the annular rim for stabilizing the mixing extension component;
a manual rotating component;
an adapter component configured to be secured to the connector component; and
wherein the adapter component and the manual rotating component each includes a threaded exterior surface for engaged receipt of a corresponding thread on the connector component such that a user can selectively and interchangeably operate the mixer using the drill and the manual rotating component.
